(19) United States
(12) Patent Application Publication
(10) Pub. No.: US 2009/0262120 A1
(43) Pub. Date: Oct. 22, 2009

(54) METHOD FOR LOADING IMAGES AND ELECTRONIC DEVICE

(75) Inventor: Chung-Huan Mei, Taoyuan (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HTC Corporation, Taoyuan County (TW)

(21) Appl. No.: 12/323,527

(22) Filed: Nov. 26, 2008

(30) Foreign Application Priority Data
Apr. 18, 2008 (TW) 97114283

(51) Int. Cl. G06F 13/00; G06F 3/041

(52) U.S. Cl. 345/536; 345/173

(57) ABSTRACT

An image loading method applied to an electronic device having a display is provided. The method has the following steps. Firstly, an image is decompressed into a second bitmap file. Afterward, a bitmap attribute is obtained according to the second bitmap file. Following, a bitmap attribute is obtained according to the second bitmap file. Then, the bitmap attribute corresponding to an image is accessed. Next, a first bitmap file is generated in a first system memory according to the bitmap attribute. Then, the first bitmap file is outputted to the display.

This application claims the benefit of Taiwan application Serial No. 97114283, filed Apr. 18, 2008 the subject matter of which is incorporated herein by reference.

### BACKGROUND OF THE INVENTION

1. Field of the Invention

The invention relates in general to an image loading method and an electronic device, and more particularly to an image loading method and an electronic device capable of saving memory space and quickly loading image.

2. Description of the Related Art

Generally speaking, the image format that can be used in programs is bitmap format. Normally, the image is stored in the format of png or gif, and when the program needs to load the image, the image is decompressed into the bitmap format.

Referring to FIG. 1, a conventional image loading method applied in an electronic device is shown. Firstly, the method begins at step S110, all images (png or gif) of the electronic device are respectively decompressed into a bitmap file. Then, the method proceeds to step S120, the bitmap files are loaded into the memory of the electronic device. Then, the method proceeds to step S130, the bitmap files that need to be displayed are outputted to the display of the electronic device from the memory. However, the method of pre-loading all bitmap files to the memory occupies too much memory space, making the electronic device unable to function stably.

Referring to FIG. 2, another conventional image loading method applied in an electronic device is shown. Firstly, the method proceeds to step S210, the image that needs to be displayed are decompressed into a bitmap file and the bitmap file is stored in the memory of the electronic device. Then, the method proceeds to step S220, the bitmap file is outputted to the display of the electronic device from the memory. However, the required time for decompressing an image file of png or gif format into bitmap format normally ranges from tens to hundreds of milliseconds. The method which loads the image file only when the image file needs to be displayed takes a large amount of time to decompress the image into a bitmap file and then outputs the bitmap file to be displayed on the display. Therefore, the electronic device has very low efficiency in displaying an image. Particularly, such image loading method is unable to provide a smooth display of continuous image for the electronic device which needs to display a continuous frame.

### SUMMARY OF THE INVENTION

The invention is directed to an image loading method and an electronic device. When the electronic device needs to display an image, a bitmap file is generated in a system memory according to a pre-obtained bitmap attribute. Thus, the memory space is saved and the image is loaded instantly.

According to a first aspect of the present invention, an image loading method applied to an electronic device having a display is provided. The method has the following steps. Step a, an image is decompressed into a second bitmap file. Step b, a bitmap attribute is obtained according to the second bitmap file. Step c, the bitmap attribute corresponding to an image is accessed. Step d, a first bitmap file is generated in a first system memory according to the bitmap attribute. Step e, the first bitmap file is outputted to the display.

According to a second aspect of the present invention, an image loading method used for displaying a continuous frame on a display of an electronic device is provided. The method has the following steps. Step a, each of a plurality of images is respectively decompressed into a second bitmap file. Step b, a plurality of corresponding bitmap attributes are obtained according to the second bitmap files. Step c, one of the bitmap attributes is accessed, wherein each bitmap attribute respectively corresponds to an image. Step d, a first bitmap file is generated in a first system memory according to the accessed bitmap attribute. The first system memory is a volatile memory. Step e, the first bitmap file is sequentially outputted to the display according to an order. Step f, another one of the bitmap attributes is accessed and the step d and the step e are repeated until all of the first bitmap files that need to be displayed on the display have been outputted so as to display a continuous frame.

According to a third aspect of the present invention, an electronic device including a first system memory, a display and a processing unit is provided. The processing unit is used for accessing a bitmap attribute corresponding to an image. The processing unit further generates a first bitmap file in the first system memory according to the bitmap attribute. Besides, the processing unit further accesses another bitmap attribute corresponding to another image and further generates another first bitmap file in the first system memory according to another bitmap attribute so as to display the first bitmap file and the another first bitmap file on the display. The processing unit sequentially displays the first bitmap file and the another first bitmap file on the display according to an order. The first system memory is a volatile memory.

### BRIEF DESCRIPTION OF THE DRAWINGS

FIG. 1 (Prior Art) shows a conventional image loading method applied in an electronic device;

FIG. 2 (Prior Art) shows another conventional image loading method applied in an electronic device;

FIG. 3 shows a block diagram of an electronic device according to an embodiment of the invention;

FIGS. 4A˜4C respectively simulate the rotation of a cube on a display;

FIG. 5 shows a flowchart of an image loading method according to an embodiment of the invention;

FIG. 6A shows a flowchart of a method for generating a plurality of bitmap attributes according to the invention; and

FIG. 6B shows a flowchart of an image loading method according to another embodiment of the invention.

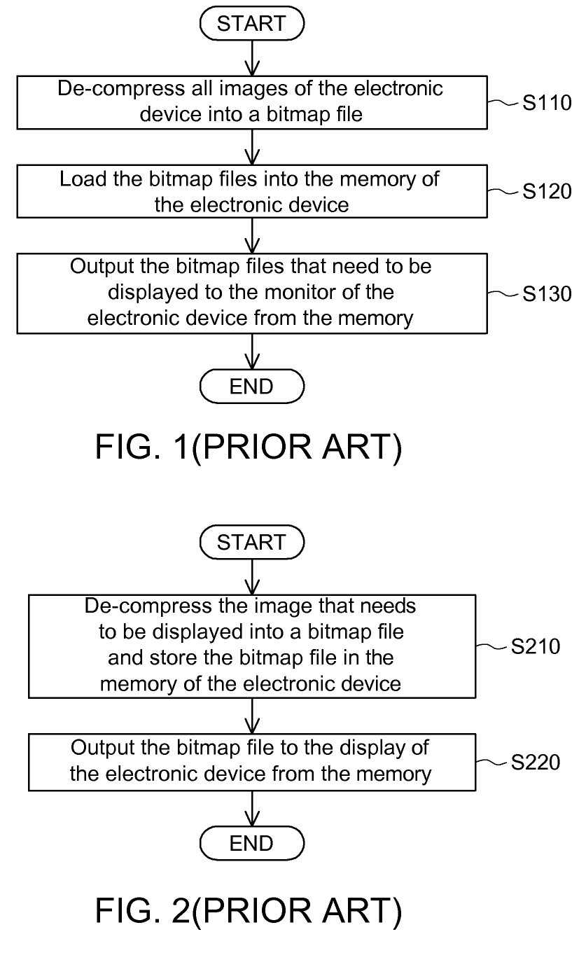

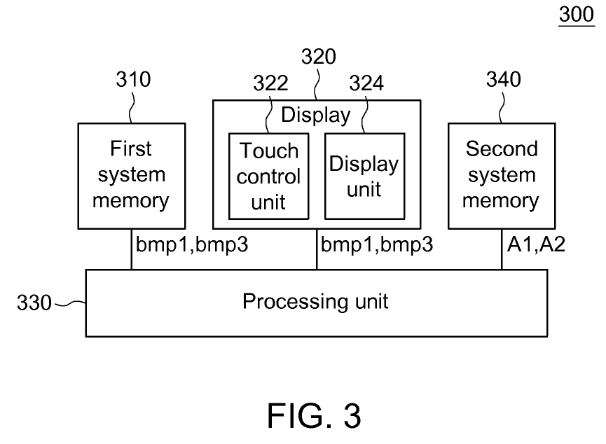

### DETAILED DESCRIPTION OF THE INVENTION

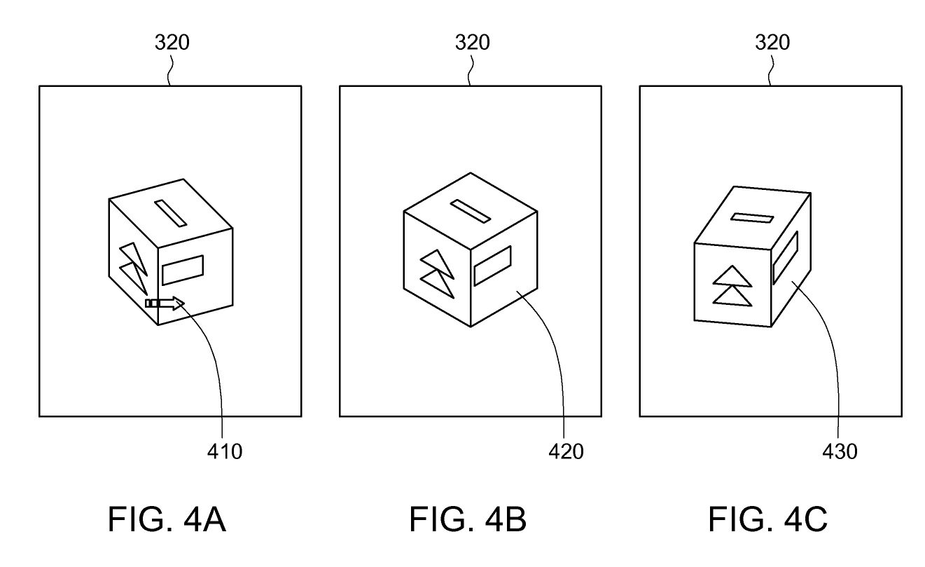

Referring to FIG. 3, a block diagram of an electronic device according to an embodiment of the invention is shown. The electronic device 300, such as a smartphone, a touch phone, a personal digital assistant (PDA), PDA phone or a mobile computer includes a first system memory 310, a display 320 and a processing unit 330. The processing unit 330 is used for accessing a bitmap attribute A1 corresponding to an image E1. The processing unit 330 generates a bitmap file bmp1 in the first system memory 310 according to the bitmap attribute A1 so as to display the bitmap file bmp1 on the display 320. The bitmap file bmp1, for example, is a pattern displayed on the electronic device 300 under windows mobile operating system. The image E1 is in the format of png, bmp or gif for example.

The processing unit 330 is linked to an application-programming interface (API) of the windows mobile operating system for generating the bitmap file bmp1 according to the bitmap attribute A1. Therefore, the user can view the first bitmap file bmp1 within a very short period of time (approximately 2˜10 milliseconds). Thus, the required time for the electronic device 300 to display a pattern is reduced such that the user can have a better experience in use. Besides, the processing unit 330 generates the bitmap file bmp1 in the first system memory 310 according to the bitmap attribute A1 only when the bitmap file bmp1 needs to be displayed, hence effectively saving memory space for the electronic device 300.

In the present embodiment of the invention, the first system memory 310 is a volatile memory such as a dynamic random access memory (DRAM), a static random access memory (SRAM) or a cache memory. After the bitmap file bmp1 is displayed on the display 320, the processing unit 330 further releases the bitmap file bmp1 from the first system memory 310.

In order to obtain the bitmap attribute A1 corresponding to the image E1, the image E1 is decompressed into a bitmap file bmp2, and the bitmap attribute A1 is obtained according to the bitmap file bmp2. In the present embodiment of the invention, the bitmap attribute A1 includes at least one of the attributes including the width, the height, the bit number of each pixel and the bit data of each pixel of the bitmap file bmp2. Preferably, the bitmap attribute A1 records at least one of the attributes including the width and the height of the bitmap file bmp2, the bit number of each pixel and the bit data of each pixel according to a file format. The file is a text file having the format of txt for example.

The bitmap attribute A1, for example, is directly generated in the electronic device 300. The bitmap attribute A1 can be generated in a personal computer and the electronic device 300 can be connected to the personal computer for transmitting the bitmap attribute A1 to the electronic device 300.

Moreover, the electronic device 300 further includes a second system memory 340 used for storing the bitmap attribute A1. In the present embodiment of the invention, the second system memory 340 is a non-volatile memory such as a read only memory (ROM), an electrically erasable and programmable read only memory (EEPROM) or a flash memory. Therefore, after the electronic device 300 is re-booted, the bitmap attribute A1 is still stored in the second system memory 340. Thus, when the bitmap file bmp1 needs to be displayed on the display 320 again, the processing unit 330 can directly access the bitmap attribute A1 from the second system memory 340 to generate the bitmap file bmp1 accordingly. Thus, the required time for generating the bitmap attribute A1 is reduced.

In the present embodiment of the invention, the display 320 includes a touch control unit 322 and a display unit 324. When the touch control unit 322 receives an input signal, the processing unit 330 is activated to access the bitmap attribute A1 and generate a bitmap file bmp1 so as to display the bitmap file bmp1 on the display unit 324. The input signal, for example, is the signal generated when the user drags a movement trace on the display 320. The input signal can also be the signal when the user clicks the display 320 or operates an interface such as a physical button or wheel of the electronic device 300.

In the present embodiment of the invention, the electronic device 300 is exemplified by the case of displaying a single pattern. However, in other embodiments, the electronic device 300 can further be used to display a continuous frame. The continuous frame is achieved by displaying multiple patterns quickly and continuously. The continuous frame is exemplified below by the case of displaying two patterns.

The processing unit 330 is further used to access another bitmap attribute A2 corresponding to another image E2. The processing unit 330 generates another bitmap file bmp3 in the first system memory 310 according to the bitmap attribute A2 so as to display two bitmap files bmp1 and bmp3 on the display 320. The processing unit 330 sequentially displays the bitmap file bmp1 and bmp3 on the display 320 according to an order. The required time for the processing unit 330 to generate the bitmap files bmp1 and bmp3 is very short. Therefore, when the bitmap files bmp1 and bmp3 are continuously and quickly displayed on the display 320, a motion picture effect is created.

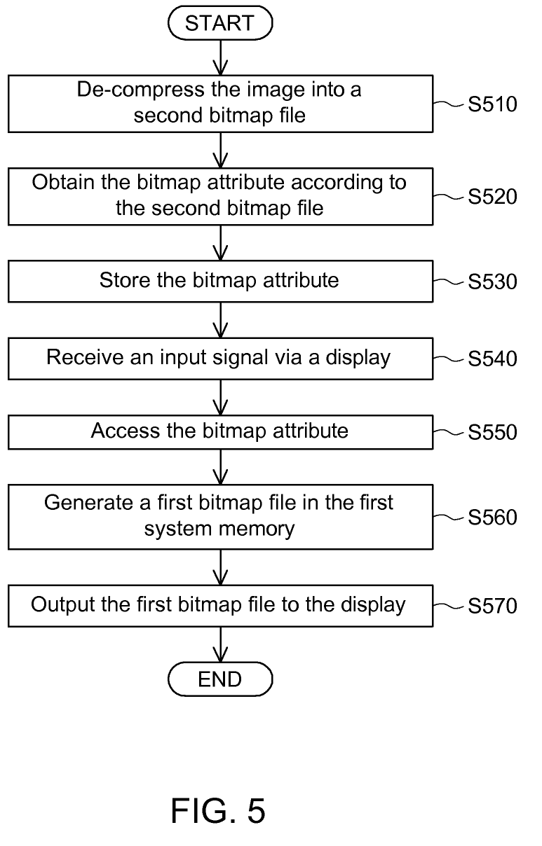

The continuous frame is exemplified by the rotation of a cube. Referring to FIGS. 4A˜4C, the rotation of a cube on a display 320 is simulated. When the display 320 receives an input signal generated when the user drags a movement trace 410 or when the electronic device 300 receives a signal generated when the user operates an interface such as a physical button or wheel, the bitmap files 420 and 430 are continuously and quickly displayed on the display 320. Thus, the rotation of cube displayed on the display 320 is very smooth, such that the user has the feeling of operating a physical cube.

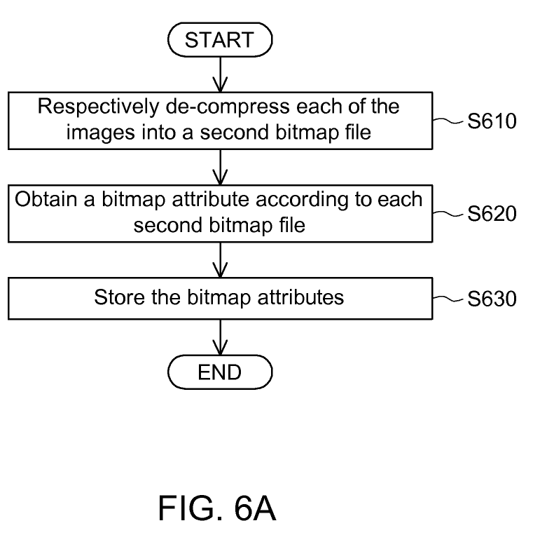

A method for loading an image of a single pattern according to an embodiment of the invention is disclosed below with a flowchart. Referring to FIG. 5, a flowchart of an image loading method according to an embodiment of the invention is shown. The embodiment is exemplified by the case of displaying a single pattern. Firstly, the method begins at step S510, an image E1 is decompressed into a bitmap file bmp2 in the format of png, bmp or gif for example.

Next, the method proceeds to step S520, a bitmap attribute A1 is obtained according to a bitmap file bmp2, wherein the bitmap attribute A1, for example, records at least one of the attributes including the width and the height of the bitmap file bmp2, the bit number of each pixel and the bit data of each pixel according to a file format.

Then, the method proceeds to step S530, the bitmap attribute A1 is stored in a second system memory 340 such as a non-volatile memory for example. Afterwards, the method proceeds to step S540, an input signal is received via a display 320. The input signal, for example, is a signal generated when the user drags a movement trace on the display 320, clicks the display 320 or operates an interface such as a physical button or wheel of the electronic device 300.

After that, the method proceeds to step S550, the bitmap attribute A1 is accessed. Then, the method proceeds to step S560, a bitmap file bmp1 is generated in the first system memory 310 according to the bitmap attribute A1. In the step S560, the bitmap file bmp1 may be generated by linking an application programming interface (API) of the windows mobile operating system. Next, the method proceeds to step S570, the bitmap file bmp1 is outputted to the display 320.

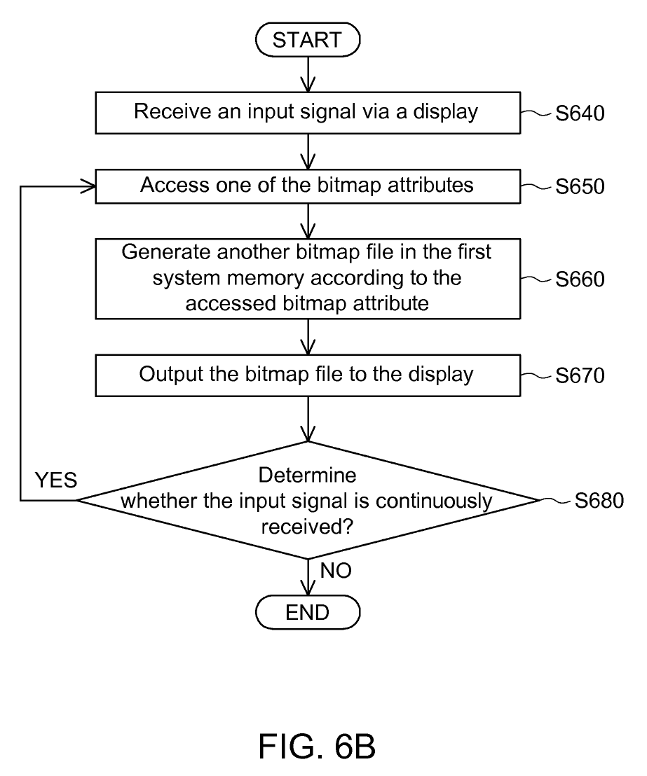

A method for loading an image of a continuous frame according to an embodiment of the invention is disclosed below with a flowchart. The method is exemplified by the case of continuously and quickly displaying the continuous frame achieved by the bitmap files 420 and 430 of FIGS. 4A˜4C. The bitmap files 420 and 430 are respectively generated according to a bitmap attribute. Referring to FIG. 6A, a flowchart of a method for generating a plurality of bitmap attributes according to the invention is shown.

Firstly, the method begins at step S610, the image sE1 and E2 are respectively decompressed into the bitmap files bmp2 and bmp4. Next, the method proceeds to step S620, the bitmap attributes A1 and A2 are respectively obtained according to the bitmap files bmp2 and bmp4. Then, the method proceeds to step S630, the bitmap attributes A1 and A2 are stored. Thus, the bitmap attribute A1 corresponding to the bitmap file 420 and the bitmap attribute A2 corresponding to the bitmap file 430 are obtained.

Referring to FIGS. 4A˜4B and FIG. 6B. FIG. 6B shows a flowchart of an image loading method according to another embodiment of the invention. In the image loading method of FIG. 6B, the bitmap files 420 and 430 are generated according to the bitmap attributes A1 and A2 of FIG. 6A.

Then, the method proceeds to step S640, an input signal is received via a display 320. The input signal is a signal generated when the user drags a movement trace 410 (illustrated in FIG. 4A) on the display 320 or operates an interface of the electronic device 300 such as a physical button or a wheel. Then, the method proceeds to step S650, the bitmap attribute A1 is accessed. Afterwards, the method proceeds to step S660, a bitmap file bmp1 is generated in the first system memory 310 according to the bitmap attribute A1. After that, the method proceeds to step S670, the bitmap file bmp1 is outputted to the display 320.

Next, the method proceeds to step S680, whether the input signal is continuously received via the display 320 is determined: if not, the image loading method terminates, otherwise the step S650 is repeated. Thus, the bitmap files 420 and 430 are quickly and continuously displayed on the display 320 to achieve a continuous frame. The bitmap file bmp1 (the bitmap file 420) and the bitmap file bmp3 (the bitmap file 430) are sequentially outputted to the display 320 according to an order.

According to the image loading method of the present embodiment of the invention, the steps in FIG. 5, FIG. 6A and FIG. 6B are executed by an electronic device 300 but the invention is not limited thereto. Anyone who is skilled in the technology of the invention will understand that the steps of the image loading method and the orders thereof can be modified and adjusted according to actual needs.

The image loading method can be compiled into programming codes and be executable on the electronic device 300.

An image loading method and an electronic device are disclosed in the above embodiments of the invention. A bitmap file is generated in a system memory according to the bitmap attribute so as to display one single pattern or a continuous frame having multiple patterns on the display. The bitmap file is generated according to the corresponding bitmap attribute only when the bitmap file needs to be displayed, hence effectively saving memory space. Also, the bitmap attribute records relevant parameters of the bitmap file and the bitmap file can be generated within a very short period of time. Therefore, the required time for the pattern to be displayed is reduced so that the user can have better experience of use and product competiveness is increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image loading method applied to an electronic device having a display, wherein the image loading method comprises:
a. decompressing an image into a second bitmap file;
b. obtaining a bitmap attribute according to the second bitmap file;
c. accessing the bitmap attribute corresponding to the image;
d. generating a first bitmap file in a first system memory according to the bitmap attribute, wherein the first system memory is a volatile memory; and
e. outputting the first bitmap file to the display.

2. The image loading method according to claim 1, wherein the bitmap attribute comprises at least one of the attributes comprising the width and the height of the second bitmap file, the bit number of each pixel and the bit data of each pixel.

3. The image loading method according to claim 2, wherein the bitmap attribute records at least one of the attributes comprising the width and the height of the second bitmap file, the bit number of each pixel and the bit data of each pixel according to a file format.

4. The image loading method according to claim 1, wherein after the step b, the method further comprises:
f. storing the bitmap attribute.

5. The image loading method according to claim 4, wherein in the step f, the bitmap attribute is stored in a second system memory which is a non-volatile memory.

6. The image loading method according to claim 1, wherein the display comprises a touch control screen, and before the step c, the method further comprises:
receiving an input signal via the touch control screen, wherein the input signal comprises a movement trace.

7. An image loading method applied in a display of an electronic device for displaying a continuous frame, wherein the image loading method comprises:
a. respectively decompressing each of a plurality of images into a second bitmap file;
b. obtaining a plurality of corresponding bitmap attributes according to the second bitmap files;
c. accessing one of the bitmap attributes each corresponding to an image respectively;
d. generating a first bitmap file in a first system memory according to the accessed bitmap attribute, wherein the first system memory is a volatile memory;
e. sequentially outputting the first bitmap file to the display according to an order; and
f. accessing another bitmap attribute and repeating the step d and the step e until all the first bitmap files that need to be displayed on the display have been outputted so as to display the continuous frame.

8. The image loading method according to claim 7, wherein each bitmap attribute comprises at least one of the attributes comprising the width and the height of each corresponding second bitmap file, the bit number of each pixel and the bit data of each pixel.

9. The image loading method according to claim 8, wherein each bitmap attribute records at least one of the attributes comprising the width and the height of each corresponding second bitmap file, the bit number of each pixel and the bit data of each pixel according to a file format.

10. The image loading method according to claim 7, wherein after the step b, the method further comprises:
g. storing the bitmap attributes.

11. The image loading method according to claim 10, wherein in the step g, the bitmap attributes is stored in a second system memory which is a non-volatile memory.

12. The image loading method according to claim 7, wherein the display comprises a touch control screen, and before the step c, the method further comprises:
receiving an input signal via the touch control screen.

13. The image loading method according to claim 12, wherein the input signal comprises a movement trace formed on the touch control screen.

14. An electronic device, comprising:
a first system memory;
a display; and
a processing unit used for accessing a bitmap attribute corresponding to an image, for generating a first bitmap file in the first system memory according to the bitmap attribute, for accessing another bitmap attribute corresponding to another image and further for generating another first bitmap file in the first system memory according to another bitmap attribute so as to display the first bitmap file and the another first bitmap file on the display;
wherein the processing unit sequentially displays the first bitmap file and the another first bitmap file on the display according to an order;
wherein the first system memory is a volatile memory.

15. The electronic device according to claim 14, wherein the bitmap attribute is obtained according to a second bitmap file formed by decompressing the corresponding image.

16. The electronic device according to claim 15, wherein the bitmap attribute comprises at least one of the attributes comprising the width and the height of the second bitmap file, the bit number of each pixel and the bit data of each pixel.

17. The electronic device according to claim 16, wherein the bitmap attribute records at least one of the attributes comprising the width and the height of the second bitmap file, the bit number of each pixel and the bit data of each pixel according to a file format.

18. The electronic device according to claim 14, further comprising:
a second system memory used for storing the bitmap attribute;
wherein the processing unit accesses the bitmap attribute from the second system memory;
wherein the second system memory is a non-volatile memory.

19. The electronic device according to claim 14, wherein the display comprises:
a touch control unit; and
a display unit, wherein when the touch control unit receives an input signal, the processing unit accesses the bitmap attribute and generates the first bitmap file accordingly so as to display the first bitmap file on the display unit.

20. The electronic device according to claim 19, wherein the input signal comprises a movement trace.
